(19) United States
(12) Patent Application Publication
(10) Pub. No.: US 2011/0041381 A1
(43) Pub. Date: Feb. 24, 2011

(54) Bait dispenser

(76) Inventor: Bryan Gary Houghton, Sidcup Kent (GB)

Correspondence Address: J. Bruce Hoofnagle, PO Box 370, Lisbon, MD, 21765-0370, US

(21) Appl. No.: 12/805,534

(22) Filed: Aug. 4, 2010

(30) Foreign Application Priority Data
Feb. 4, 2008 (GB) GB 0801984.6
Dec. 24, 2008 (GB) GB 0823551.7
Feb. 4, 2009 (GB) PCT/GB2009/050103

(51) Int. Cl. A01K 97/02

(52) U.S. Cl. 43/44.99

(57) ABSTRACT

A bait dispenser 8, for use by an angler, includes a container 9 into which bait can be loaded when the container is open. The container 9 can be closed to retain the bait therein. The bait dispenser 8 is attachable to a line for casting the bait dispenser into a body of water, where the container 9 is structured to burst open upon impact with the water.

This U.S. national stage application claims the benefit of International Application No. PCT/GB2009/050103, filed Feb. 4, 2009, which, in turn, claims the benefit of UK Application No. GB0801984.6, filed Feb. 4, 2008, and UK Application No. GB0823551.7, filed Dec. 24, 2008, all three if which are incorporated herein by this reference thereto.

### FIELD OF THE INVENTION

This invention relates to a bait dispenser for placing bait at a particular location in a body of water. In particular, this invention relates to a bait dispenser having facility for storing bait therein and for placement of the dispenser in a particular location in a body of water, and for releasing the bait from the dispenser upon impacting entry of the bait dispenser in the body of water.

### BACKGROUND OF THE INVENTION

Traditionally, in order to congregate fish in a particular area in a body of water and to encourage them to feed, an angler has formed a ball of bait of, for example, maggots in dough and has thrown them at the spot. This has inevitably been wasteful because the dough may not itself comprise the feeding medium, the dough has to be brought, or the ingredients thereof have to be brought, to the site, and because the dough may not be completely free of its occupants. Also known is a cage in the form of a finned perforated cylinder attachable to a fishing line at a rear end thereof, which rear end is open while the front end comprises a rounded float. The use of such a cage or any means not employing a matrix holding the bait together risks not all the bait arriving at the intended location.

Thus, there is a need for means for an angler to place ground bait at a desired location in a body of water in order to attract fish to an area at which the angler will be fishing.

### SUMMARY OF THE INVENTION

Accordingly, it is an object of this invention to provide means for an angler to place ground bait at a desired location in a body of water in order to attract fish to an area at which the angler will be fishing.

According to the present invention, a bait dispenser, for use by an angler, includes a container into which bait can be loaded. The container is attachable to a casting line and is structured to open upon impact of the container with a body of water.

According to features of the invention, the container may have catch means, or a catch, associated with a weight, for maintaining the container closed. Upon impact of the container with the water, movement of the container is slowed while the weight continues to travel and frees the catch to allow the container to open. The catch and the weight may be attached to a fishing line so that, while casting the container, the catch holds the container closed. To this end, or as an alternative to attaching the catch to the line, the catch may include some means of slight positive engagement with the container, for example by detent or magnet. Alternatively the catch and the weight may be held in the closed configuration by spring means such as an elastic member. Another way of keeping the catch engaged, until opening of the container is desired, is for the line, or extension thereof, to pass around a loop attached to the catch and then be anchored, for example, adjacent the proximal end of a container member, thus doubling the mechanical advantage employed by the line in holding the catch in the closure position.

If the shape of the container is such that, under casting force, the bait might tend to urge the container open. The catch may be adapted to resist this.

The catch may be arranged to be adjustable to cater for different bait loadings for example. Thus screw means may be incorporated, perhaps with an associated visual scale, for adjusting the strength of the catch. This may for example adjust the loading of a spring or the configuration of one magnet in relation to another.

Spring means may be employed to assist in driving the container open.

The container may include a plurality of members hinged one to the other which upon impact with the water are forced open. Advantageously the container includes two half-cylinder-like, mating, concave shells, hinged at one end. In order completely to fill the container with bait, the container may have a filler opening, preferably provided with movable closure means such as a slide.

Among the means for achieving a bursting open of the container upon impact with the water are fins, suitably disposed flotation devices or chambers, spring means and making the container or part thereof of a rapidly soluble material. Any one or combination of these may be suitable for a given form of fishing. Where fins are used these may be splayed outwards at an acute angle and arranged so that faces thereof impact the water and thus drive the container members apart. The fins may, if there is to be a catch in the region thereof, straddle the catch and may lightly to retain the catch in place by means of friction.

Typically, the angle of the fin to the longitudinal axis of the container may be 25°-55°, with 45° perhaps being optimum. The fins may be interchangeable or their size and shape adjustable to suit various lines and conditions.

The fin principle may be constituted or assisted by an appropriate reverse slope to the ends of the shells of the container. This may not be desired if it were to impede full discharge of the container contents. However, an adjacent volume of the container might be required for ballast or flotation purposes. Indeed, a compartment may be formed at the distal end of one or more of the shells, in which may be placed ballast or flotation material as required. The container may accordingly be constructed to act as a float after opening of the container, by incorporating a flotation chamber, including foam perhaps, at the distal end of one member, and perhaps suitable ballast means may be located at the distal end of another or the other shell.

It may be preferred that charging the container with bait occurs after the shells of the containers have been locked together by the catch. To this end, one of the shells may incorporate filler means. Typically, the filler means may comprise an opening in the container shell, which is coverable by a sliding lid. Preferably, the sliding lid slides open towards the proximal end of the container, so that casting of the dispenser tends to hold the lid closed.

In typical operation of a dispenser according to the invention, the line is cast bearing the bait-loaded container. Upon impact with the water, the catch is released and the fins force the container open and the contents thereof spill out. The container is then withdrawn and detached from the line, to which a hook (which expression includes other fish-catching devices) is attached ready for the line to be recast. However, the container may be arranged to contain both the ground bait and the baited hook or hooks and may be arranged also to be buoyant, even to act as, or be attached to, a float.

In another embodiment of the invention, the bait dispenser has an aerodynamic shape, including a container in the form of two halves, or mating concave shells, and has a mouth at a bow, lead, or distal end thereof. The bait dispenser further includes a spring-loaded plunger mounted on one of the shells, and is located in the mouth of the container. The plunger engages a detent on the other of the two shells, where, upon the dispenser impacting the water, the plunger is driven to release the other of the two shells, thereby opening, or separating, the two shells at the distal end.

Advantageously there are fins at the rear, tail or proximal end of the bait dispenser, appropriate ones of which are hinged together for the opening of the dispenser.

The spring compression of the plunger is preferably adjustable.

In the context of angling, suitable dimensions for the bait dispenser are up to 30 cm long with an aspect ratio of up to about 5:1.

Making the container of a buoyant material can assist its deceleration and opening thereof upon impact with the water.

The two shells of the container may be manufactured of a plastics material in a mold. Typically, the container may be made of polypropylene while the plunger and adjuster may be made of nylon and the spring of spring steel. Ideally then, the hinge may be constituted by an appropriately thin portion of the molded plastics material. Alternatively a lightweight, e.g., plastics, hinge may be attached, or an adhesive strip member, or metal, plastics, or cord rings, may form the hinge. Again, interlocking portions of the hinge may be formed in the mold, with hollows and detents forming the fulcrum, so that the two halves of the molding can be clipped together. However, instead of a hinge, temporary fasteners such as press studs or even magnets may be used.

### BRIEF DESCRIPTION OF THE DRAWINGS

Bait dispensers in accordance with the present invention will now be described by way of example with reference to the accompanying figures, of which:

FIG. 1 is perspective view showing a first embodiment of a bait dispenser; in an open position, in accordance with certain principles of the invention;

FIG. 2 is a side view of showing a second embodiment of a bait dispenser, in an open position, in accordance with certain principles of the invention;

FIG. 3 is a side view showing a third embodiment of a bait dispenser, in an open position, in accordance with certain principles of the invention;

FIG. 4 is a perspective view showing a fourth embodiment of a bait dispenser, in an open position, in accordance with certain principles of the invention;

FIG. 5a is a side view showing a fifth embodiment of a bait dispenser, in a closed position, in accordance with certain principles of the invention;

FIG. 5b is a side view showing the fifth embodiment of the bait dispenser of FIG. 5a, in an open position, and having an adjustable mechanical catch, in accordance with certain principles of the invention;

FIG. 6a is a side view showing a sixth embodiment of the bait dispenser, having adjustable magnetic catch means, in accordance with certain principles of the invention;

FIG. 6b is top view showing the sixth embodiment of the bait dispenser of FIG. 6a, having adjustable magnetic catch means, in accordance with certain principles of the invention;

FIG. 7 is a sectional view showing a seventh embodiment of bait dispenser, in a closed configuration, in accordance with certain principles of the invention;

FIG. 8 is a sectional view showing one of two shells of a container of the seventh embodiment of the bait dispenser of FIG. 7, in accordance with certain principles of the invention;

FIG. 9 is a perspective view showing the seventh embodiment of the bait dispenser of FIG. 7, in an open configuration, in accordance with certain principles of the invention;

FIG. 10 is a diagrammatic view showing the seventh embodiment of the bait dispenser of FIG. 7, in an open configuration; in accordance with certain principles of the invention:

FIG. 11 is a diagrammatic end view showing a fin arrangement of the seventh embodiment of the bait dispenser of FIG. 7, in accordance with certain principles of the invention;

FIGS. 12 through 14 are views showing hinge arrangements which may be used with the various embodiments of the bait dispenser of the invention;

FIG. 15 is a sectional side view showing an eighth embodiment of a bait dispenser, in a closed mode, in accordance with certain principles of the invention; and

FIG. 16 is a sectional side view of the eighth embodiment of the bait dispenser of FIG. 15, in an open mode, in accordance with certain principles of the invention.

### DESCRIPTION OF THE PREFERRED EMBODIMENTS

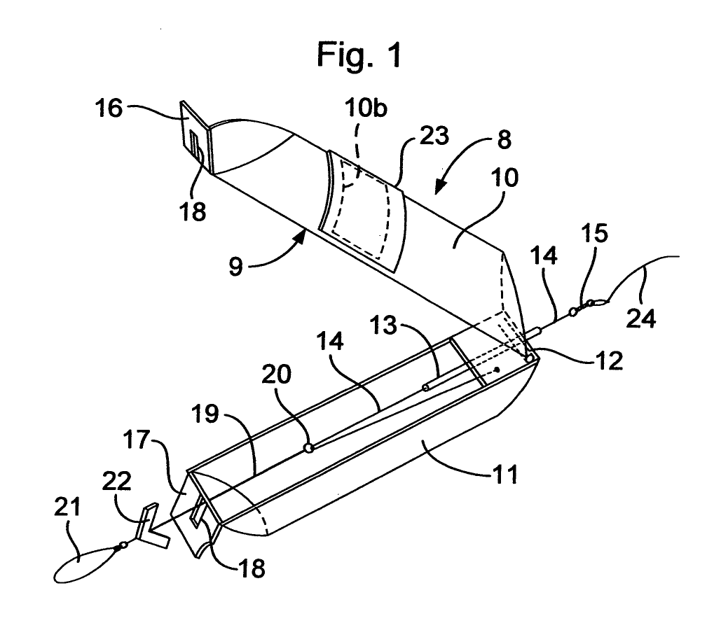

As shown in FIG. 1 a first embodiment of a bait dispenser 8 is formed by a container 9, which includes two cylindrical-like halves, in the form of a first concave shell 10 and a second concave shell 11. The shells 10 and 11 are attached, one to the other, at a proximal end of the container by a hinge 12, which facilitates the joined retention of the shells as they are moved between a closed mode and an open mode. In assembly of the container 9, the shells 10 and 11 are placed in mating engagement, such that concave portions of the shells are in an interfacing orientation when the container is closed, and are spaced, but connected by the hinge 12, when the container is in the open mode. When the container 9 is in the closed mode, the interfacing concave portions of the shells 10 and 11 define a bait containing hollow. A tube 13 extends outward and inward through the hinged, or proximal, end of the container 9, with a portion of a fishing line 14 being movable freely therethrough. An interior portion of the line 14, which is located within the container 9, passes through a ring 20, and is looped back and anchored to a portion 11a of the shell 11 adjacent the proximal end of the container. Another portion of the line 14, which is located outside the proximal end of the container 9 is coupled to a line attachment link 15

At a distal end of the container 9, fins 16 and 17 are integrally joined with the shells 10 and 11, respectively. Each of the fins 16 and 17 are splayed outwards at an acute angle, for example 45°, from an axis of the container 9, with faces of the fins being contiguous with their respective shell 10 and 11. The fins 16 and 17 are formed with slots 16a and 17a, respectively, which, when the container is in the closed mode, combine to define a passage 18. The distal end of the container 9 is formed with a passage, which allows free movement therethrough of a bar 19 attached to the ring 20 and is, thereby, coupled to the interior portion of line 14. A weight 21 is attached to a distal end of the bar 19, and a generally V-shaped catch 22 is also attached to the bar near the distal end thereof, and slightly inward of the weight 21, with a concavity of the V-shaped catch facing the distal end of the shell 11. Opposite free ends of the V-shaped catch 22 fit snugly through the passages 16a and 17a to latch the shells 10 and 11 in the closed mode, when the container 9 is closed.

The weight 21 is shaped as a cylindrical hydrofoil to assist in ready and rapid movement through water. The generally V-shaped catch 22 is also shaped, and oriented, to flow readily through water.

An opening 10b is formed through an intermediate wall of the shell 10 of the container 9, which is coverable by a slide 23. The slide 23 is arranged to open by sliding towards to hinge, or proximal, end of the container 9.

In use, the bait dispenser 8 is attached at line attachment link 15 to a fishing line 24. With the container 9 in the open mode, the shell 11 of the container 9 is filled with bait and the two shells 10 and 11 are closed and latched together by the catch 22. With the slide 23 open, more bait is stuffed into the container 9 through the opening 10b, and the slide is closed.

The fishing line 24 is then cast, whereby the bait dispenser 8 is propelled through the air to a selected location in the body of water. Upon impact with the water, the momentum of the container 9 is decreased due to the orientation of the fins 16 and 17 and, to some extent, the size, shape and heaviness of the bait-loaded container. However, due to the physical heaviness and the hydrofoil properties of the weight 21, and to the manner in which the weight is coupled to the distal end of the freely movable bar 19, the weight continues to move through the water, and advances ahead of the distal end of the slower moving container 9. As the weight 21 advances ahead of the distal end of the container 9, the bar 19, which is attached to the weight, also advances with the weight. As the bar 19 advances, relative to the container 9, the catch 22, which is attached to the advancing bar, also advances relative to the container, whereby the catch is separated from latching engagement with the container.

As the catch 22 separates from the container 9, the bait-loaded container enters an unlatched mode and the two shells 10 and 11 begin to pivotally separate from each other at the distal ends thereof, and about the hinge 12 at the proximal ends of the shells. In this manner, the container 9 is thereby opened, and the loaded bait begins to flow out of the hollow formed by the previously interfacing concave shells 10 and 11, and flows into, and floats in, the surrounding water at the selected location. Fish begin to congregate around the floating bait. The fishing line 24 is then reeled in and the bait dispenser 8 is replaced with a baited hook and float. Thereafter the angler casts the baited hook and float into the selected area of the water in search of a successful fishing trip.

In the above-described first embodiment, the container 9 is 15 cm in length and 3 cm in width, and the fins are at an acute angle, such as, for example, 45°, to the axis of the container axis, as noted above. The container 9 is made of a lightweight plastics material and the hinge 12 is made of a flexible plastics material.

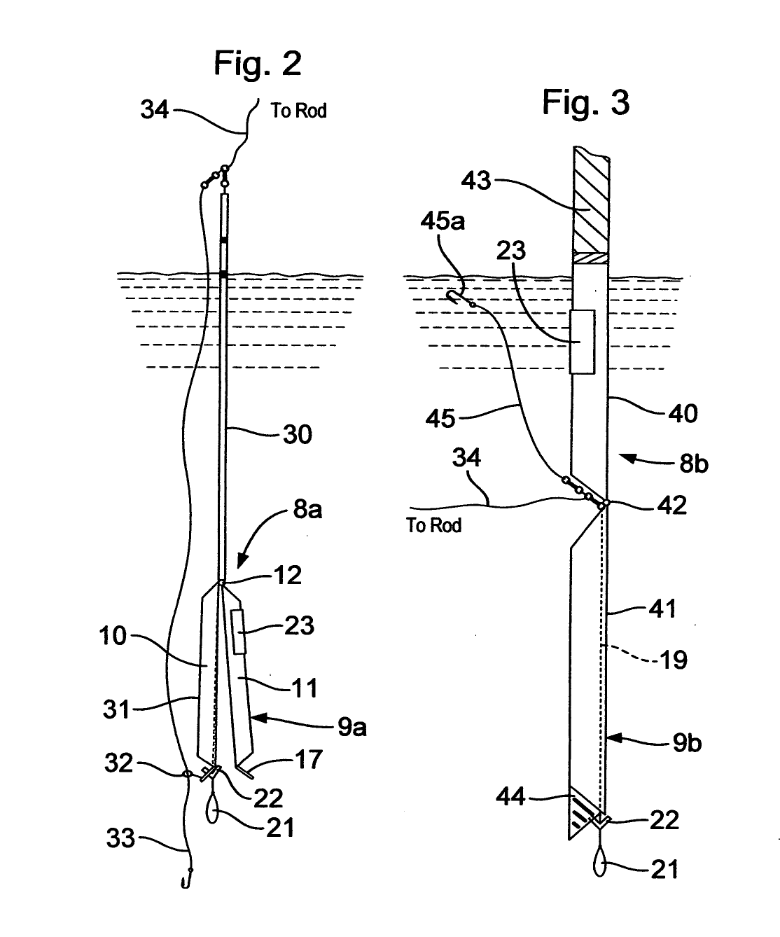

Referring to FIG. 2, in a second embodiment of a bait dispenser 8a, the tube 13 is omitted and the line 14 is replaced by an elastic thread or cord 31, which is attached at the proximal end of a container 9a such that, until impact with the water, the elastic thread retains the catch 22 in latching place. Upon impact of the bait dispenser 8a with the water, the elastic thread 31 expands due to the momentum of the weight 21 to permit the catch 22 to release and the shells 10 and 11 to open.

In the second embodiment of the bait dispenser 8a, illustrated in FIG. 2, the container 9a is attached, at the proximal end thereof, to a float 30 and the catch 22, at the distal end of the container, is held in place by the elastic thread 31. An eye 32 keeps a fishing hook assembly 33 in the region of the container 9a, with the fishing hook assembly being attached to a fishing line 34. Parts generally similar to those illustrated in FIG. 1 are similarly referenced.

The second embodiment of the bait dispenser 8a, illustrated in FIG. 2, is intended for depositing the bait in a region which is a short distance below the surface of the water, to facilitate catching fish in that region.

In a third embodiment of a bait dispenser 8b, illustrated in FIG. 3, the bait dispenser includes a container 9b, which has two half cylinders 40 and 41, or shells, hinged at a proximal end of the container by a hinge 42. The proximal end of each the shells 40 and 41 is rebated, or angled at, 45° and is arranged for the fitment of flotation foam 43 and a weight 44, respectively. A fishing hook assembly 45 is attached to the hinge 42 as is the fishing line 34. The cord 19, which holds the weight 21, is attached to the line 34 and the arrangement is such that, until the bait dispenser 8b impacts with the water, the container 9b is held closed by the catch 22. Upon impact with the water, the catch 22 is pulled away, or released, from the container 9b as movement of the container in the water is somewhat arrested while the weight 21 continues onward. The force of the water upon the rebated end surfaces of the shells 40 and 41 drives those ends apart and allows dispensing of the bait from the container 9b.

The distal end of the container shell 40, in the form of the floatation foam 43, is arranged to protrude above the water surface and thus to be visible in the manner of the traditional fishing float. The distal end of the container shell 41 depends below the container half 40 due to the weight 44. Parts generally similar to those illustrated in FIG. 1 are similarly referenced.

The third embodiment illustrated in FIG. 3 is suitable for surface fishing where a hook 45a is intended to be close to the surface of the water.

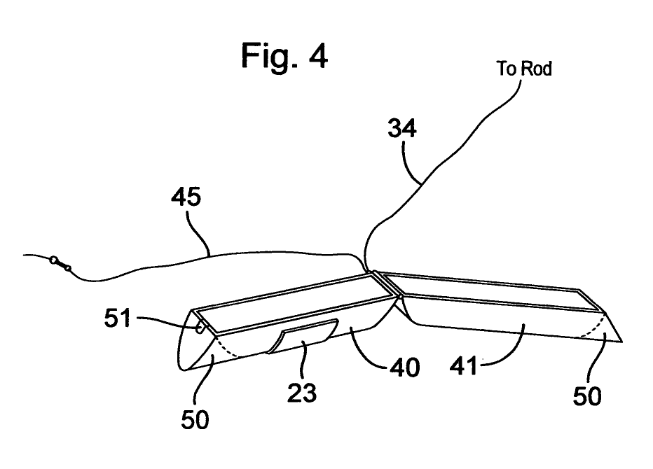

In the a fourth embodiment of a bait dispenser 8c, illustrated in FIG. 4, the distal ends of the shells 40 and 41 each contain a weight 50, and are also fitted with a small magnet 51 arranged to retain a container 9c in the closed mode until impact of the bait dispenser 8c with the water. The force exerted upon the distal ends of the shells 40 and 41, which force is developed when the bait dispenser 8c impacts with the water, drives the shells apart.

The fourth embodiment of the bait dispenser 8c, illustrated in FIG. 4, is arranged for bottom fishing, on the bed of the water.

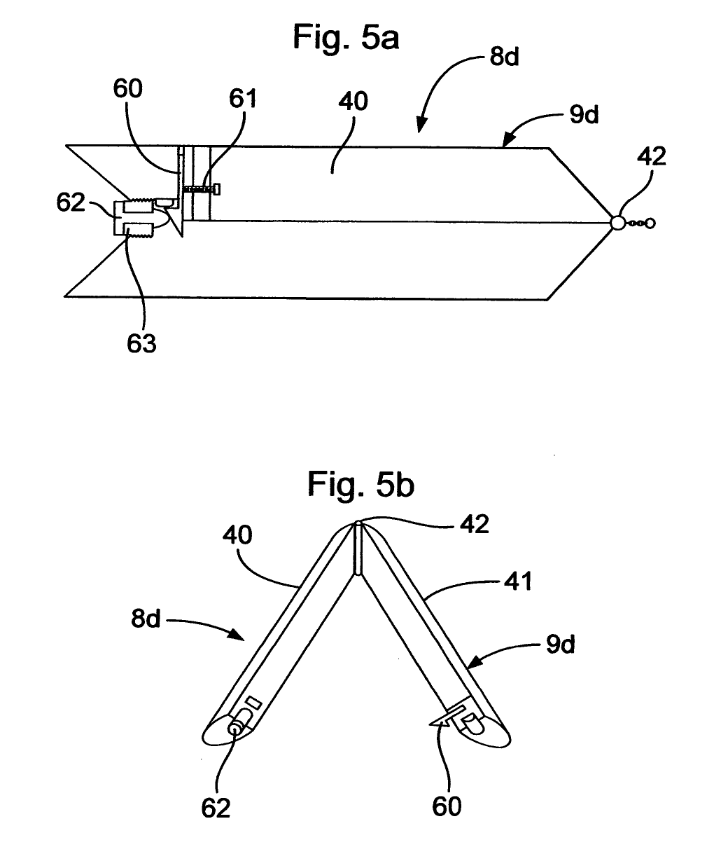

In a fifth embodiment of a bait dispenser 8d, illustrated in FIGS. 5a and 5b, a catch 60 is located within the shells 40 and 41 of a container 9d. Screw adjustable spring means 61 urges a hook end 60a of the catch 60 into a position to maintain the container 9d closed. Protruding from the distal end of the container 9d is a pressure pad 62 arranged to float freely in the longitudinal direction and to bear upon the catch 60. The pad 62 is, however, keyed to an adjuster block 63, which is screwed into one of the shells 40 and 41. Turning the pad 62 adjusts the extent to which the pad protrudes into the container 9d and thereby establishes the travel required to open, or release, the catch 60.

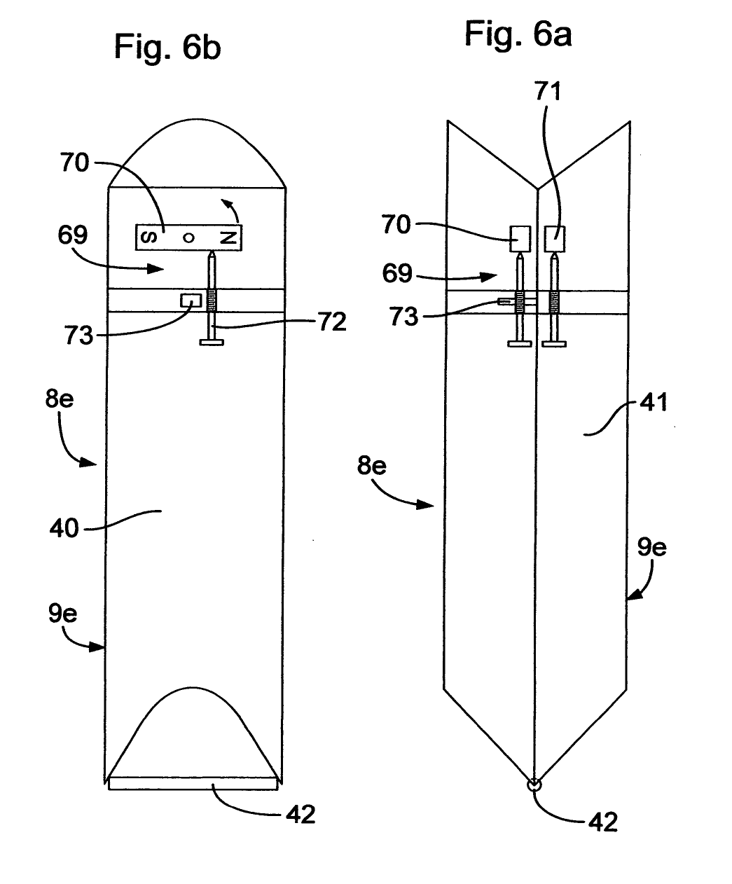

In a sixth embodiment of a bait dispenser 8e, illustrated in FIGS. 6a and 6b, a catch is formed by rotatable magnets 70 and 71, one mounted in each of the two shells 40 and 41 of a container 9e. Screw means 72 sets the angle of the magnets 70 and 71 relative to an axis of the container 9e, and thus the force by which the magnets hold the shells together. Detent means 73 assist the alignment of the shells 40 and 41, one to the other, when the container 9e is in the closed mode.

In some embodiments of the bait dispensers, described above with reference to FIGS. 1 through 6b, the two shells are formed in a single mold and the hinge is formed by making the molded material thin at the hinge region.

In other embodiments of the above-described bait dispensers, a hinge portion is molded with two interfitting hinge parts having lateral mating detents and protrusions. The hinge is then formed by snapping the two hinge parts together.

In yet other embodiments of the above-described bait dispensers, a hinge portion is molded with interfitting parts, which are not fully closed.

In yet other embodiments of the above-described bait dispensers, the hinge is replaced by a magnet.

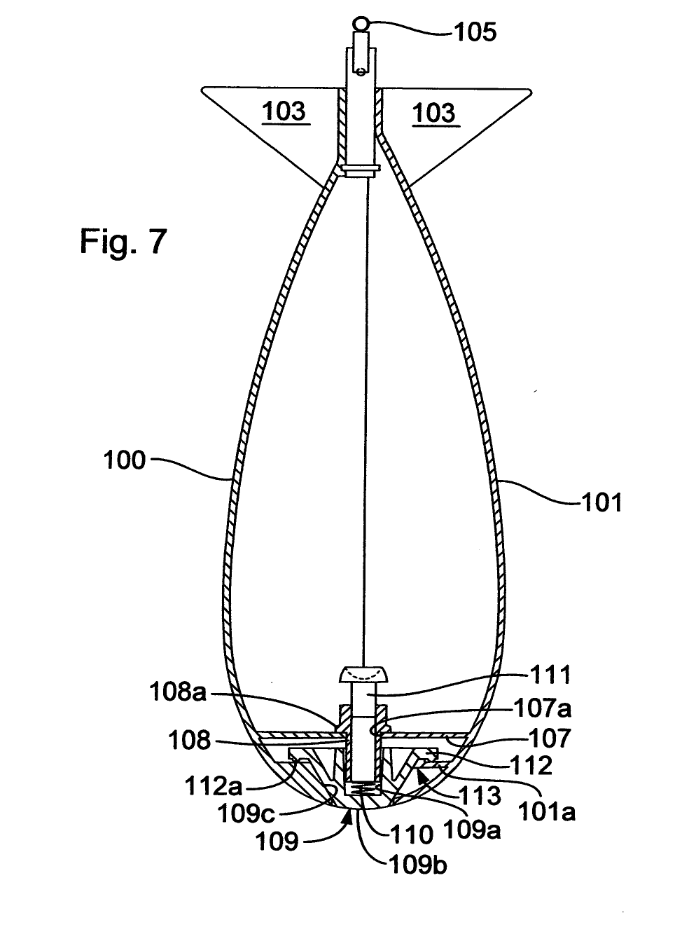

In a seventh embodiment of a bait dispenser 8f, illustrated in FIGS. 7 through 11, the bait dispenser includes an aerodynamically teardrop-shaped container 9f, which is formed by the mating assembly of two halves 100 and 101, or shells, as illustrated in FIG. 7. Each of the shells 100 and 101 is formed with a concave opening, which mates, and interfaces, with the concave opening of the other shell, when the shells are assembled together, to form a bait-receiving hollow of the container 9f.

As shown in FIGS. 7, 8 and 9, a line link 105 is assembled with the shell 100, and includes an eye 105a, a support shaft 105b, and an annular flange 105c formed about and extending radially outward from the support shaft. The flange 105c fits into a partial annular groove 100a formed in the shell 100. When the shells 100 and 101 are assembled to form the container 9f, major axial portions of the support shaft 105c are surrounded and captured in an accommodating opening 105d formed by the assembled shells. A pair of cords 106 extend from the line link 106, and are anchored to the interiors of the shells 100 and 101.

When assembled, the container 9f includes four flight-stabilizing fins 103, located at the proximal end of the container. The fins 103 are spaced from each other by ninety degrees from the adjacent two fins. The fins 103 extend laterally, or radially, of the axis of the container 9f, and are normal to a center line, or axis, of the bait dispenser 8f.

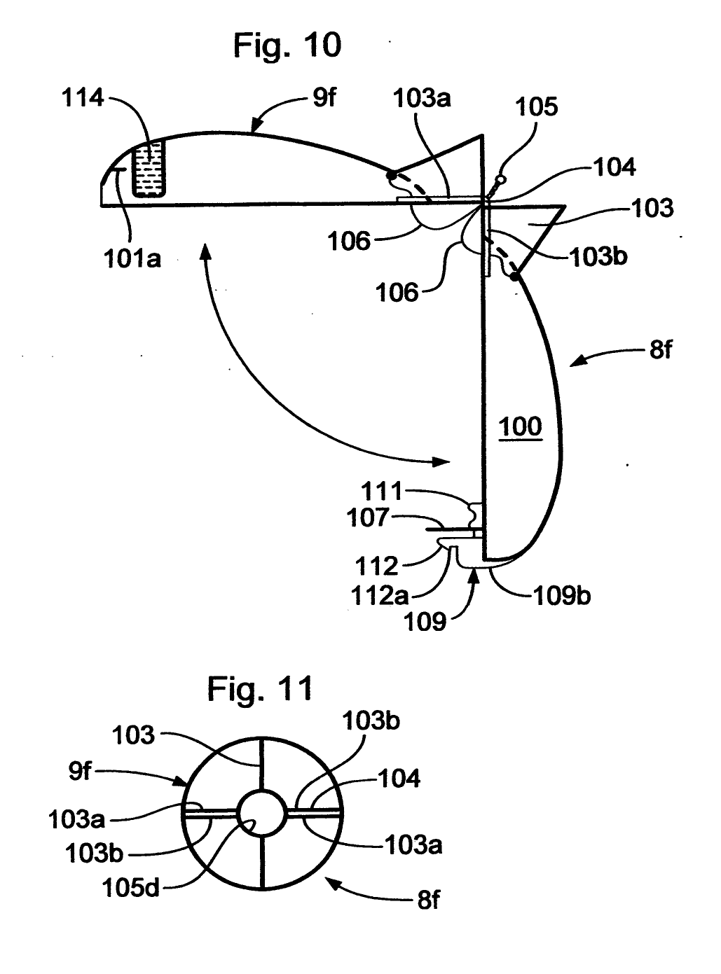

Referring to FIGS. 10 and 11, each of the shells 100 and 101 is formed with one full fin 103, defined by having a full thickness, and two spaced half fins 103a and 103b, each being defined by being formed with a thickness which is generally one-half the thickness of the full fin 103. Other than the difference in thickness, the fins 103, 103a, and 103b are identical in configuration. Each of the half fins 103a and 103b, of each of the shells 100 and 101, are located laterally on opposite sides of the full fin 103, are spaced ninety degrees therefrom, and are spaced from each other by one hundred and eighty degrees along opposite edges of the respective one shell, which mate with corresponding edges of the other shell to form the container 9f.

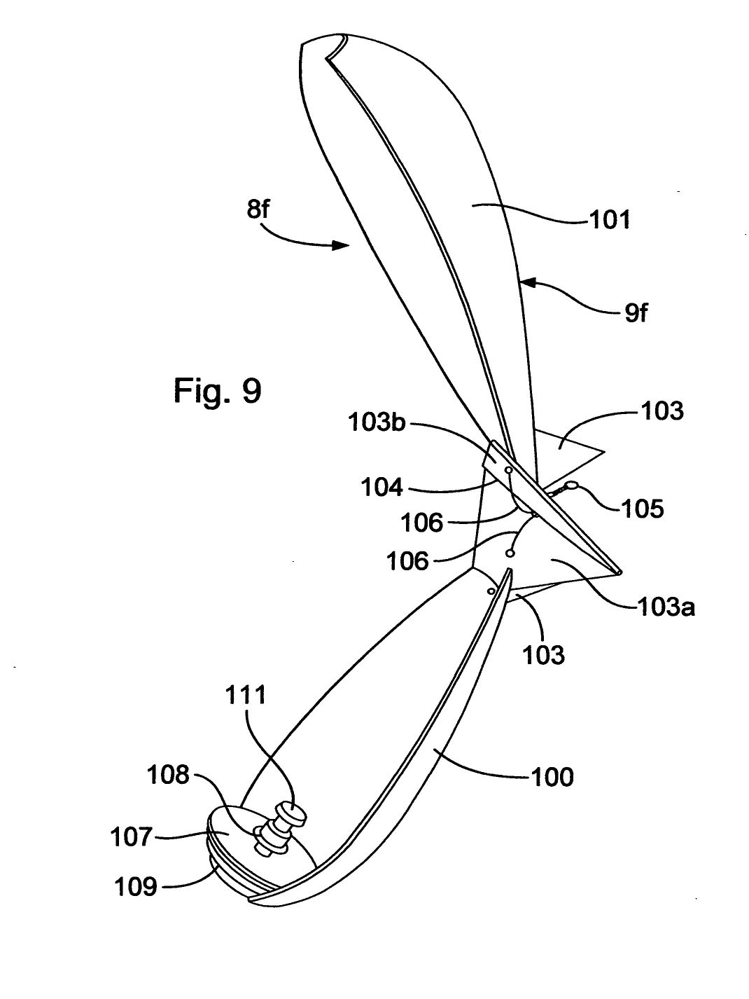

As shown in FIGS. 10 and 11, the shells 100 and 101 are hinged along a hinge juncture line 104 (FIGS. 9, 10, and 11) located adjacent the proximal ends of the half fins 103a and 103b of each of the shells. When the shells 100 and 101 are closed to form the container 9f, the half fins 103a and 103b of the shell 100 are moved into interfacing alignment, and are complimentary, with the half fins 103b and 103a, respectively, of the shell 101, to, in effect, form two of the four fins 103 of the container.

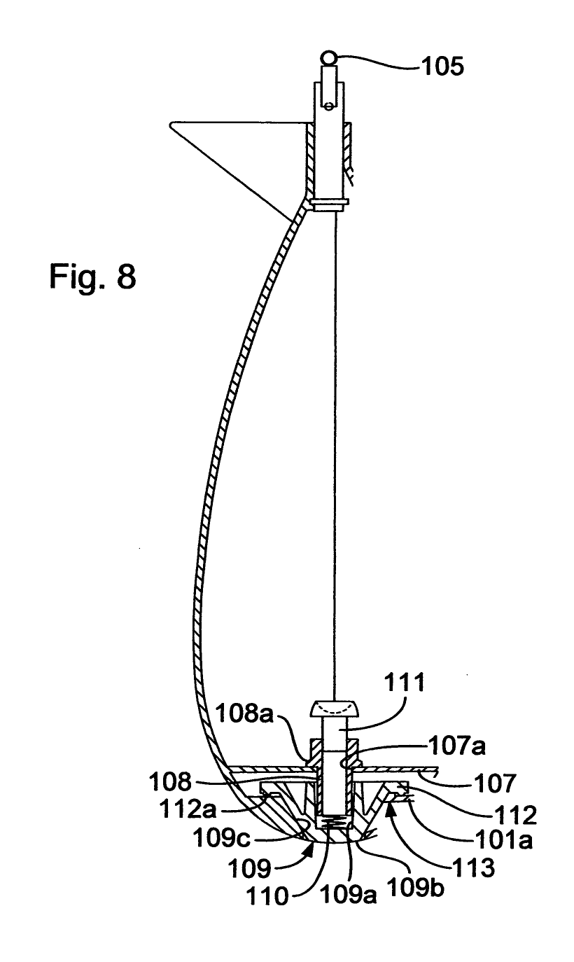

Referring to FIGS. 7 and 8, at the distal, or bow, end of the container 9f, the shell 100 is formed with a radially-extending, circular platform 107, having an axial opening 107a formed through the platform. A plunger holder 108, which is positioned through the opening 107a, is formed with an external, radial flange 108a resting on a proximal surface 107b of the platform 107. The plunger holder 108 is located within a bore 109a of a cup-shaped plunger 109 and incorporates a spring 110 and a spring stiffness adjuster 111. A base 109b of the cup-shaped plunger 109 fits into an opening 109c, or mouth, formed at the distal end of the closed container 9f, with the base 109b protruding slightly in the distal direction from the container.

The plunger 109 is formed with a radially outward flange 112 having a circular ridge 112a extending from the underside of the flange, and concentrically about the axis of the bait dispenser 8f. The ridge 112a is arranged to locate radially outward of, and to engage, a protrusion 101a, which extends in a proximal direction from an inside wall of the shell 101. Functionally, the ridge 112a and the protrusion 101a form a detent 113 (FIG. 7), or catch, internally in the shell 101. When the shell 100 is assembled with the shell 101 in the closed position, the ridge 112a engages the protrusion 101a, in the form of a catch, to latch the two shells together and thereby retain the container 9f in the closed position.

In one embodiment, the two shells 100 and 101 are formed in a single mold and the hinge 104 is formed by making the molded material thin at the hinge region.

In another embodiment, a hinge portion is molded wherein the interfitting hinge members have lateral mating detents and pimples to facilitate the attachment of the two hinge parts together.

In yet another embodiment a hinge portion is moulded with the interfitting members not fully closed.

In yet another embodiment the hinge 104 is replaced by a magnet.

In the seventh embodiment of the bait dispenser 8f, illustrated in FIG. 10, a foam block 114 is fitted to the shell 101, by which the bait the dispenser is transformed into a float after the bait contents have been dispersed from the container 9f.

In use of the seventh embodiment of the bait dispenser 8f, the shell 100 of the open bait dispenser is heaped with bait and the two shells 100 and 101 are then snapped shut. That is to say, the hinge 104 is manipulated to bring the shells 100 and 101 together, and the ridge 112a and the protrusion 101a of the detent 113 engage to hold the dispenser closed. If not already attached, the bait dispenser 8f is attached to a fishing line via the line link 105.

After the line is then cast, the bait dispenser 8f impacts the water, where the exposed base 109b of the plunger 109 initially impacts the water and the plunger is pushed, against the biasing action of the spring 110, in a proximal direction farther into the container 9f. As the plunger 109 is pushed into the closed container, the ridge 112a separates from engagement with protrusion 101a, against the biasing action of the spring 110, thereby releasing the detent 113 to open the container 9f. Ingress of water between the plunger 109 and the shells 100 and 101 assists in urging the shells farther apart, to allow the bait to exit the bait dispenser 8f.

Typically the bait dispenser 8f of the seventh embodiment has an aspect ratio of approximately 3:1.

The plunger 109 functions as a means for detecting impact of the container 9f with the water, and also functions as a means responsive to detecting impact of the container with the water for releasing the detent 113 to open the container.

In a particular example of the seventh embodiment of the bait dispenser 8f, which is recommended for use in carp fishing, the bait dispenser is 19 cm long and has a maximum diameter of 6.5 cm

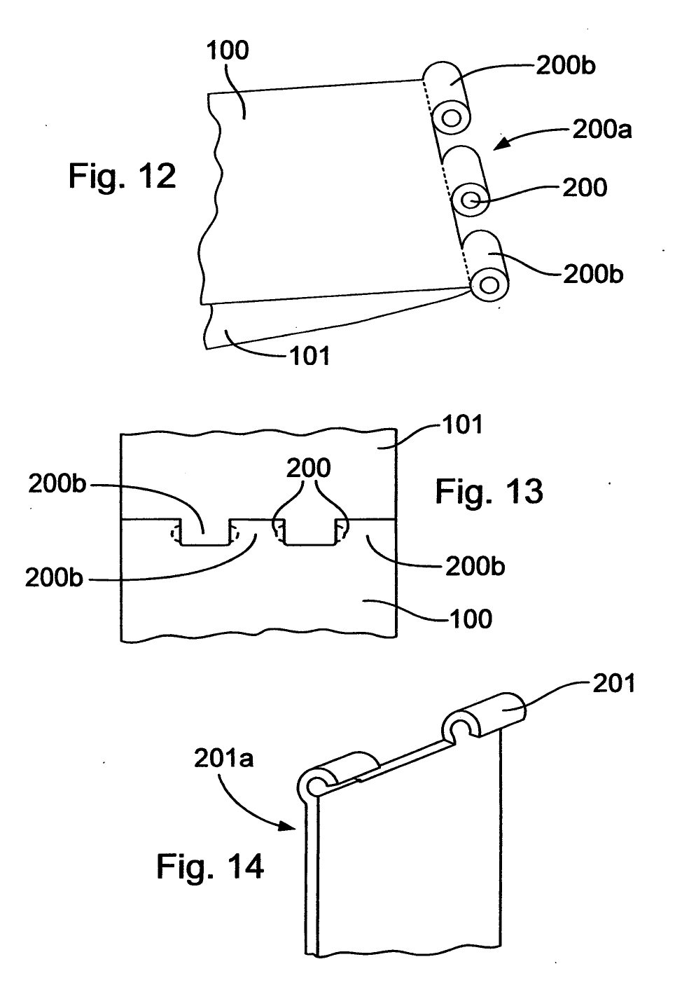

Various hinge arrangements are illustrated in FIGS. 12 through 14. Referring to FIGS. 12 and 13, hinge sections 200a are molded into the shells 100 and 101 with interfitting hinge members 200b molded with corresponding mating dimples and recesses 200, whereby the hinges may be snapped together.

Referring to FIG. 14, the hinge sections 201a are molded with hook-shaped interfitting hinge members 201 to facilitate molding.

It will be appreciated that, without departing at all from the scope of the present invention, the container shells may be formed with a compartment at the distal ends thereof for containing flotation foam, ballast, bait, one or more hooks, or nothing, as required.

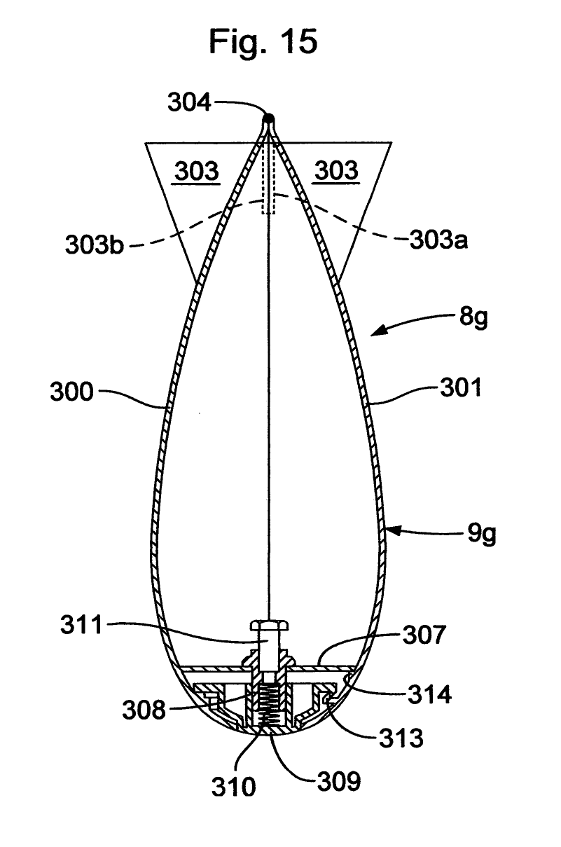

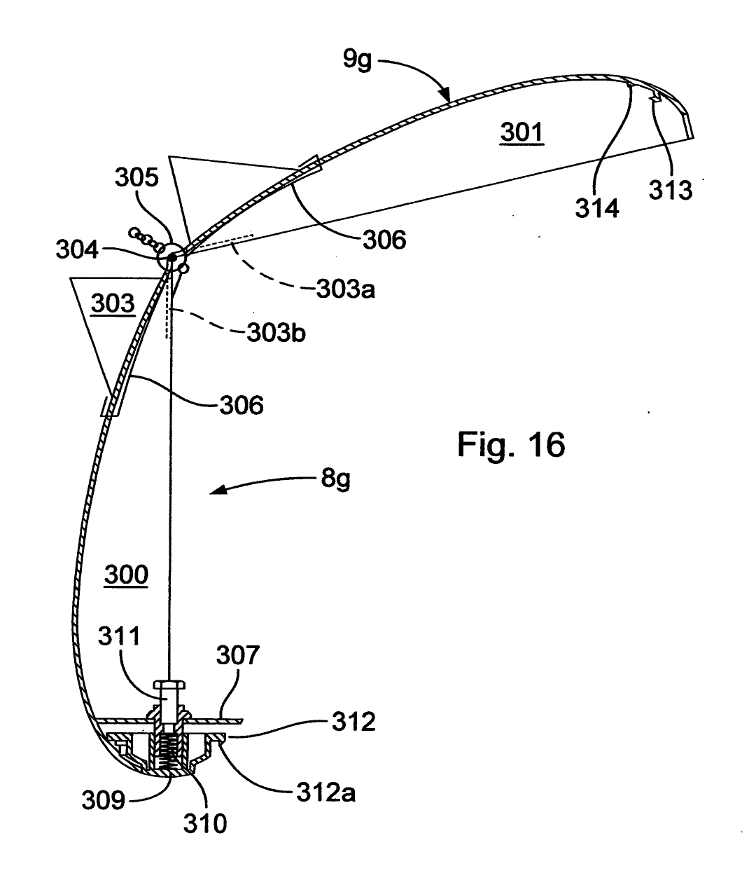

An eighth embodiment of a bait dispenser 8g, illustrated in FIGS. 15 and 16, is similar in structure and function as the structure and function of the seventh embodiment of the bait dispenser 8f, illustrated in FIGS. 7 through 11. One example of the similarity is that a base 309a of a plunger 309 impacts the water to initiate the opening of a closed container 9g.

Referring to FIGS. 15 and 16, the bait dispenser 8g includes the aerodynamically teardrop-shaped container 9g, formed by two shells 300 and 301, with each shell having flight stabilising fins 303 at the proximal end thereof. At the mating face of the two shells 300 and 301, both of the shells are formed with half-thickness fins 303a and 303b, in the same complementary manner described above with respect to the half fins 103a and 103b in the seventh embodiment of the bait dispenser 8f. The proximal or tail ends of the fins 303a and 303b are normal to the center line of the bait dispenser 8g and are hinged one to the other at a hinge juncture 304.

The hinge at juncture 304 is called a “live hinge” and is formed by molding the hinge as more or less a membrane in the same plastics material along the span of the two sets of fins 303a and 303b as part of the molding of the two shells 300 and 301 together. Also, at the proximal end of the shells 300 and 301, a line link 305 is provided, with wire springs 306 anchored to the two shells 300 and 301. The purpose of the wire springs 306 is to relieve loading by the link 305 upon the hinge at the juncture 304. The line link 305 provides facility for attaching the fishing line to the bait dispenser 8g, and to the fishing hooks.

It is noted that the fins 303 extend farther forward than the fins 103 illustrated in FIGS. 7, 8. While only two fins 103 or 303 could be used with the bait dispensers 8f and 8g, respectively, four fins are preferred for consistency during line casting in windy conditions.

In the same context as the distal end of the container 9f, as described above, at the distal, or bow, end, of the container 8g, the shell 300 is formed with a platform 307 upon which is centrally mounted a plunger holder 308. The plunger holder 308 supports a plunger 309, and incorporates a spring 310 and a spring stiffness adjuster 311.

Similarly to the structure of the container 8f, the plunger 309 is formed with a flange 312 having a circular rib 312a on the underside thereof, which is arranged to engage a protrusion 301a formed in the shell 301. The ridge 312a and the protrusion 301a combine to form a detent 313, or catch, which retains the shells 300 and 301 together when the container 9g is in the closed mode.

A ledge 314 is formed inside the shell 301 to facilitate the locating of the platform 307, when the shells 300 and 301 are closed.

As shown in FIG. 15, the two closed shells 300 and 301 form a mouth 309a through which a base 309b of the plunger 309 protrudes slightly.

In use of the eighth embodiment of the bait dispenser 8g, the shell 300 of the open bait dispenser is heaped with bait and the two shells 300 and 301 are then snapped shut. That is to say, the hinge 304 is closed and the detent, formed by the ridge 312a and the protrusion 301a, holds the container 9g closed. If not already attached, the bait dispenser 8g is attached to a fishing line via the line link 305.

After the line has been cast, the base 309b of the plunger 309 impacts the water, whereby the plunger is pushed into the closed container 9g against the biasing action of the spring 310, thereby releasing the detent 313. Ingress of water between the plunger 309 and the shells 300 and 301 assists in urging the shells apart, to allow the bait to exit the bait dispenser 8g.

It has been found that, with appropriate spring lightness and plunger size, the bait dispenser 8g will burst open upon initial impact of other portions of the bait dispenser rather than the base 309b of the plunger 309.

The plunger 309 functions as a means for detecting impact of the container 9g with the water, and also functions as a means responsive to the detecting of the impact of the container with the water for releasing the detent 313 to open the container.

Typically the bait dispenser 8g of the eighth embodiment has an aspect ratio of approximately 3:1.

In a particular example, the bait dispenser 8g, which is recommended for use in carp fishing, is 19 cm long and has a maximum diameter of 6.5 cm.

The bait dispenser 8g of the eighth embodiment may also be readily made to act as a float, as with the embodiments described with reference to FIGS. 1 through 5 of the accompanying drawings. This may be effected by placing a foam block in a hollow formed in one, or perhaps both, of the shells 300 and 301. Of the two shells 300 and 301, the shell, which is not supporting the plunger 309, may be preferred to include the float material, while the weighted shell which supports the plunger can then hang below the shell which includes the float material.

The embodiments illustrated in FIGS. 6 through 11 and 15 and 16 are molded in polypropylene, with the plunger and plunger adjuster formed of nylon and the spring formed of spring steel. Like parts in the embodiments illustrated in FIGS. 1 through 5 may be formed of like materials.

In general, the above-identified embodiments are not to be construed as limiting the breadth of the present invention. Modifications, and other alternative constructions, will be apparent which are within the spirit and scope of the invention as defined in the appended claim

What is claimed is:

1. A bait dispenser for use by an angler, which comprises:
a container structured to receive bait therein;
the container formed by two shells;
the two shells being closable to close the container and retain the bait within the container;
the container being attachable to a casting line; and
a catch operable to hold the container closed and to permit the container to burst open upon impact with water.

2. The bait dispenser as claimed in claim 1, which further comprises:
the catch including a spring, a hook member and a detent for the hook member.

3. The bait dispenser as claimed in claim 1; which further comprises:
the catch including a magnet.

4. The bait dispenser as claimed in claim 1, which further comprises:
a weight associated with the catch and operable to free the catch upon continued travel of the weight after the container impacts the water.

5. The bait dispenser as claimed in claim 1, which further comprises:
a hinge formed with the container by which the two shells are attached one to the other.

6. The bait dispenser as claimed in claim 1, which further comprises:
at least one fin formed on the container.

7. The bait dispenser as claimed in claim 1, which further comprises:
the shells are hinged at a common end thereof; and
at least one of the shells having a fin splayed outward at an acute angle at one end thereof and arranged so that the fin faces the water when the container impacts the water.

8. The bait dispenser as claimed in claim 1, which further comprises:
the container having dimensions of the order of 10 to 20 cm in length and 3 to 10 cm in width.

9. The bait dispenser as claimed in claim 1, which further comprises:
the container formed with an end which impacts the water; and
the catch includes a plunger located at the end of the container.

10. The bait dispenser as claimed in claim 9, which further comprises:
the plunger is formed of nylon.

11. The bait dispenser as claimed in claim 1, which further comprises:
the container being formed in an aerodynamic shape.

12. The bait dispenser as claimed in claim 6, which further comprises:
the container formed with an end which is attachable to the casting line; and
the fins are located at the end of the container.

13. The bait dispenser as claimed in claim 12, which further comprises:
the container is formed with four fins of substantially equal shape, size and disposition around the end of the container.

14. The bait dispenser as claimed in claim 12, which further comprises:
the shells are hinged together at a juncture of at least two of the fins.

15. The bait dispenser as claimed in claim 1, which further comprises:
a spring attached to the shells at a rear end thereof and arranged to drive the shells apart and to provide a link operable to attach the container to a fishing line.

16. The bait dispenser as claimed in claim 1, which further comprises:
the container is formed from polypropylene.

17. A bait dispenser for use by an angler, which comprises:
a container structured to receive bait,
the container having a proximal, or tail, end and a distal, or bow end;
two shells of substantially similar shape and size which when in apposition define an aerodynamic shape;
four fins at the tail end of the container, each having a leading edge and a trailing edge, of substantially similar size and shape and disposition around the container;
the two shells being hinged together via the trailing edge of two of the fins;
a catch operable to hold the container closed and to permit the container to burst open upon impact with water;
the catch including a spring, a hook member and a detent for the hook member;
a spring attached to the body parts at the tail end thereof and arranged to drive the shells apart; and
a link to attach the dispenser to a fishing line.

18. The bait dispenser as claimed in claim 17, which further comprises:
the container having dimensions of the order of 10 to 20 cm in length and 3 to 10 cm in width.

19. A bait dispenser for use by an angler, which comprises:
a container having an aerodynamic shape;
a first shell and a second shell combinable to form the container;
the container formed with a line-connection end for connecting a casting line to the container for facilitating casting of the container into a body of water;
the container formed with an impact end, spaced from the line-connection end, which initially impacts the water following casting of the container;
a catch located at the impact end of the container for retaining the container in a closed mode; and
means located at the impact end of the container for initially detecting impact of the container with the water.

20. The bait dispenser as claimed in claim 19, which further comprises:
means responsive to the detecting of impact of the container with the water for releasing the catch to facilitate opening of the container upon impact thereof with the water.
